(19) United States
(12) Patent Application Publication
(10) Pub. No.: US 2018/0013125 A1
(43) Pub. Date: Jan. 11, 2018

(54) SECONDARY BATTERY AND ASSEMBLED BATTERY INCLUDING A PLURALITY OF SECONDARY BATTERIES

(71) Applicant: Sanyo Electric Co., Ltd., Daito-shi, Osaka (JP)

(72) Inventors: Takayuki HATTORI, Hyogo (JP); Hiroyuki HASHIMOTO, Hyogo (JP); Kazunari HIRAIDE, Osaka (JP)

(73) Assignee: Sanyo Electric Co., Ltd., Daito-shi, Osaka (JP)

(21) Appl. No.: 15/550,072

(22) PCT Filed: Feb. 24, 2016
(86) PCT No.: PCT/JP2016/000977

§ 371 Date: Aug. 10, 2017

(30) Foreign Application Priority Data
Feb. 27, 2015 (JP) 2015-039371

(51) Int. Cl. H01M 2/34; H01M 2/20; H01M 2/04; H01M 2/30; H01M 10/00

(52) U.S. Cl. CPC H01M 2/34; H01M 2/30; H01M 10/00; H01M 2/04; H01M 2/20; H01M 2220/20

(57) ABSTRACT

An object is to reduce the overall height and outside dimensions of a secondary battery. Another object is to prevent the secondary battery from being damaged by nut tightening torque. A secondary battery includes an electrode body (15), an outer can (11), a sealing plate (12), a pair of electrode terminals (13), and a short-circuit mechanism (20). The pair of electrode terminals (13) includes a first electrode terminal (13A) and a second electrode terminal (13B). The short-circuit mechanism (20) includes a conductive reversible plate (22) secured to the sealing plate (12), and a reversible plate receiver (25) disposed opposite the reversible plate (22). The reversible plate receiver (25) includes a first output terminal (31), and the first output terminal (31) is electrically insulated from the sealing plate (12). The first output terminal is electrically connected to the first electrode terminal, and is spaced from the first electrode terminal.

### TECHNICAL FIELD

The present invention relates to a secondary battery having a short-circuit mechanism that is activated in response to a rise in battery internal pressure, and an assembled battery including a plurality of secondary batteries.

### BACKGROUND ART

A power supply device having an assembled battery with a high output voltage has been developed. The assembled battery is composed of many secondary batteries capable of charging and discharging and connected in series. The power supply device is used, for example, as a power supply device for vehicles. The power supply device is discharged by supplying power to a motor during running of a vehicle, and charged by a generator during regenerative braking of the vehicle. Discharging current of a battery determines the driving torque of the motor, and charging current of the battery determines the braking force of the regenerative braking. That is, the discharging current of the battery needs to be increased to increase the driving torque of the motor for accelerating the vehicle, and the battery needs to be charged with large current to enhance the regenerative braking of the vehicle. Therefore, the battery of the power supply device of this type is discharged and charged with large current. To charge and discharge batteries with large current and improve safety, batteries with an internal current interrupt device have been developed. The current interrupt device is a mechanism that interrupts current when the internal pressure of the battery becomes abnormally high.

As a battery with such an internal current interrupt device, for example, a secondary battery has been proposed, which is equipped with a mechanism that blows an internal fuse portion to interrupt current when the internal pressure of the battery exceeds a set pressure (see Patent Literature 1). As illustrated in FIG. 15, this secondary battery 101 includes an electrode body 115, collecting plates 116 connected to the electrode body 115, an outer can 111 holding the electrode body 115, a sealing plate 112 configured to hermetically seal the outer can 111, a pair of electrode terminals 113 disposed at both end portions of the sealing plate 112, a reversible plate 122 formed of a conductive material and having an edge portion joined to the sealing plate 112, and a connecting plate 123 insulated from the sealing plate 112 by an insulating member 124 and having a polarity different from that of the sealing plate 112. One of the electrode terminals 113 is insulated from the sealing plate 112 and electrically connected to the connecting plate 123. The reversible plate 122 normally bulges toward the interior region of the outer can 111, and reverses when battery internal pressure exceeds a set pressure. The secondary battery 101 is configured such that when the internal pressure of the outer can 111 increases, the reversible plate 122 reverses and comes into contact with the connecting plate 123, and the positive and negative electrodes are short-circuited. One of the collecting plates 116 has a fuse portion 121 configured to be melted by heat from overcurrent. When the battery is short-circuited, the fuse portion 121 of the collecting member 116 is melted by heat and the output of the secondary battery 101 is interrupted. The electrical connection between the electrode body 115 and one of the electrode terminals 113 is cut off.

### CITATION LIST

### Patent Literature

PTL 1: Japanese Published Unexamined Patent Application No. 2012-195278

### SUMMARY OF INVENTION

### Technical Problem

In the secondary battery 101, the connecting plate 123 is disposed on the upper surface of the sealing plate 112, with the insulating member 124 interposed therebetween, and the connecting plate 123 is secured and electrically connected to one of the electrode terminals 113. This requires the electrode terminals 113 to protrude high above the sealing plate 112, increases the amount of protrusion (t) of the electrode terminals 113, and thus increases the overall height of the secondary battery 101. In particular, the electrode terminal 113 connected to the connecting plate 123 is secured by a securing member 118 to the connecting plate 123. Therefore, when a plurality of secondary batteries 101 are connected through this electrode terminal 113 by a bus bar 106 as illustrated in FIG. 16, the electrode terminal 113 needs to be made higher by the thickness of the bus bar 106 and the thickness of a nut 109 for securing the bus bar 106. That is, the electrode terminal 113 needs to protrude further.

To secure the bus bar 106 to the electrode terminal 113 so as to couple together a plurality of secondary batteries 101, the nut 109 needs to be screwed onto a bolt portion of the electrode terminal 113 and tightened, as indicated by an arrow in FIG. 16. The resulting large torque exerted on the electrode terminal 113 may create excessive stress in the interior of the battery, and may have an adverse effect on the collecting member 116 and the electrode body 115.

The present invention has been made in view of the conventional problems describe above. An object of the present invention is to provide a secondary battery having a reduced overall height and outside dimensions, and an assembled battery including a plurality of such secondary batteries. Another object of the present invention is to provide a secondary battery and an assembled battery including a plurality of secondary batteries in which, when the plurality of secondary batteries are coupled together using bus bars and nuts, it is possible to prevent the nut tightening torque from exerting excessive stress on electrode terminals and thus to effectively prevent the secondary batteries from being damaged.

### Solution to Problem and Advantageous Effects of Invention

To achieve the objects described above, a secondary battery according to the present invention includes an electrode body including a positive electrode and a negative electrode, an outer can having an opening and holding the electrode body, a sealing plate configured to close the opening of the outer can, and a pair of electrode terminals electrically connected to the electrode body and attached to the sealing plate. The pair of electrode terminals includes a first electrode terminal insulated from the sealing plate and a second electrode terminal electrically connected to the sealing plate. The secondary battery further includes a short-circuit mechanism configured to short-circuit the first electrode terminal and the sealing plate when internal pressure of the secondary battery exceeds a set pressure. The short-circuit mechanism includes a conductive reversible plate secured to the sealing plate and configured to be activated when pressure in the outer can exceeds a set pressure, and a reversible plate receiver disposed on an upper side of the sealing plate to face the reversible plate. The reversible plate receiver includes a first output terminal, and the first output terminal is electrically insulated from the sealing plate. The first output terminal is electrically connected to the first electrode terminal and spaced from the first electrode terminal.

Note that, in the present specification, the up-and-down direction of the secondary battery is determined in each drawing.

In the configuration described above, the reversible plate receiver includes the first output terminal which is a component separate from the first electrode terminal. This can reduce the amount of protrusion of the component to which a bus bar and a nut are connected, and thus can reduce the overall height of the secondary battery. Also, since the first output terminal is spaced from the first electrode terminal, it is possible to prevent the nut tightening torque from exerting excessive stress on the electrode terminal and thus to effectively prevent the secondary battery from being damaged. Particularly in the secondary battery of the present invention which includes the short-circuit mechanism, the first output terminal is electrically connected to the first electrode terminal while being positioned by effectively using the reversible plate receiver disposed on the sealing plate. Since this eliminates the need for an additional component for positioning the first output terminal, it is possible to reduce the number of components and achieve low-cost manufacture.

Since the secondary battery includes the short-circuit mechanism of a pressure sensitive type, it is possible to ensure safety even if the battery is overcharged. When the battery is overcharged, the internal pressure of the battery is increased by gas produced inside the battery. This activates the short-circuit mechanism, and electrically connects a positive electrode terminal and a negative electrode terminal through the sealing plate. Once the short-circuit mechanism is activated, it is possible to reduce the flow of charging current into the electrode body and suppress further progress of overcharging. Energy inside the electrode body is consumed outside the electrode body.

To further improve reliability of the battery, it is preferable that a fuse portion be provided. The short-circuit mechanism and the fuse portion form a current interrupt device. That is, the current interrupt device includes the short-circuit mechanism configured to short-circuit the first electrode terminal and the sealing plate when internal pressure of the secondary battery exceeds a set pressure, and the fuse portion configured to blow by overcurrent and interrupt the current when the current interrupt device is in a short-circuit state. After the current interrupt device is activated, further progress of overcharging can be reliably prevented.

The reversible plate receiver may include a connecting plate configured to connect the first electrode terminal to the first output terminal, the first output terminal may be a bolt having a bolt portion and a head portion adjacent to one end of the bolt portion, and the bolt may be inserted in an insertion hole in the connecting plate.

The connecting plate may have a fitting recess adjacent to a lower end of the insertion hole to allow the head portion to be fitted therein. With this simple structure of the reversible plate receiver, the bolt can be secured in place in the connecting plate.

The bolt may be secured to the connecting plate by being press-fitted into the insertion hole or the fitting recess. For example, the bolt portion may be press-fitted into the insertion hole, or the head portion may be press-fitted into the fitting recess. With this configuration, the bolt can be readily and reliably secured to the connecting plate. Even when the head portion is circular in plan view, this configuration can prevent the bolt from turning freely during fastening.

The bolt may be disposed opposite the reversible plate, and when the reversible plate is activated, the reversible plate may be brought into contact with the head portion. In this configuration, the head portion of the bolt is disposed opposite the reversible plate. Then when the reversible plate is activated, the reversible plate can be brought into contact with the head portion and short-circuited. By selecting appropriate materials for the reversible plate and the bolt, the contact resistance and conduction resistance can be reduced. Also, by varying the shape and size of the bolt, the state of connection with the reversible plate can be readily adjusted.

The head portion may have a recess in a surface thereof opposite the reversible plate. With the recess in the head portion, it is possible to increase the area of contact with the reversible plate in a reversed state, and reduce the contact resistance and conduction resistance.

The head portion may have an annular raised portion on a surface thereof opposite the reversible plate. With the annular raised portion of the head portion, it is possible to increase the area of contact with the reversible plate in a reversed state, and reduce the contact resistance and conduction resistance.

The first output terminal may be a bolt having a bolt portion and a head portion adjacent to one end of the bolt portion. An insulating holder may be disposed above the reversible plate. The insulating holder may have a through hole at a position opposite the reversible plate, and the bolt may be partly inserted into the through hole and exposed at a lower surface of the insulating holder. By partly inserting the bolt into the through hole in the insulating holder, the bolt in the through hole is exposed at the lower surface of the insulating holder while being positioned in place. The bolt can thus be electrically connected to the reversible plate in a reversed state.

The insulating holder may have a stepped recess adjacent to an upper end of the through hole to accommodate the head portion. This effectively prevents the insulating holder from moving toward the reversible plate, and reliably prevents the bolt from coming into contact with the reversible plate in a normal state.

The secondary battery may include a second output terminal electrically connected to the second electrode terminal. The second output terminal, which is for outputting to the outside, may be connected to the second electrode terminal through a conductive plate disposed on an upper surface of the sealing plate, and may be spaced from the second electrode terminal.

In this configuration, the second output terminal is provided, which is a component separate from the second electrode terminal. This can reduce the amount of protrusion of the component to which a bus bar and a nut are connected, and thus can reduce the overall height of the secondary battery. Also, since the second output terminal is spaced from the second electrode terminal, it is possible to prevent the nut tightening torque from exerting excessive stress on the electrode terminal and thus to effectively prevent the secondary battery from being damaged.

The first output terminal and the second output terminal may be symmetrically arranged. With this configuration, where the first output terminal and the second output terminal are symmetrically arranged, the first output terminal and the second output terminal can be disposed opposite each other when a plurality of secondary batteries are stacked while being alternately reversed right and left. It is thus possible to connect a plurality of secondary batteries in series while ideally connecting the first output terminal and the second output terminal.

The second output terminal may be a bolt having a bolt portion and a head portion adjacent to one end of the bolt portion, and the bolt may be inserted in an insertion hole in the conductive plate. Although the second output terminal is an inexpensive bolt having a head portion adjacent to one end of a bolt portion, the second output terminal can be secured in place in the conductive plate with a simple structure.

An assembled battery according to the present invention includes a plurality of secondary batteries according to any one of those described above, and the plurality of secondary batteries are connected using bus bars and nuts coupled to the first output terminals 31. This configuration can reduce the amount of protrusion of the components to which the bus bars and the nuts are connected, reduce the overall height of the secondary batteries, and thus can reduce the outside dimensions of the assembled battery. Also, since the first output terminal is spaced from the first electrode terminal, it is possible to prevent the tightening torque exerted on the first output terminal, as illustrated in FIG. 14, from being directly applied to the first electrode terminal, and prevent the first electrode terminal and the secondary battery from being damaged.

### BRIEF DESCRIPTION OF DRAWINGS

FIG. 1 is a vertical cross-sectional view of a secondary battery according to an embodiment of the present invention.

FIG. 2 is a plan view of the secondary battery illustrated in FIG. 1.

FIG. 3 is an enlarged cross-sectional view of the secondary battery illustrated in FIG. 1.

FIG. 4 is an enlarged cross-sectional view illustrating another example of placement of a first output terminal.

FIG. 5 is an enlarged cross-sectional view illustrating another example of a first electrode terminal and a reversible plate receiver.

FIG. 6 is an enlarged cross-sectional view illustrating another example of the first electrode terminal and the reversible plate receiver.

FIG. 7 is an enlarged cross-sectional view of a main part, illustrating another example of a bolt which is the first output terminal.

FIG. 8 is an enlarged cross-sectional view of a main part, illustrating another example of the bolt which is the first output terminal.

FIG. 9 is an enlarged cross-sectional view illustrating another example of the first electrode terminal and the reversible plate receiver.

FIG. 10 is an enlarged cross-sectional view illustrating an example of a securing structure of the reversible plate receiver.

FIG. 11 is an enlarged cross-sectional view illustrating another example of the securing structure of the reversible plate receiver.

FIG. 12 is an enlarged cross-sectional view illustrating another example of the securing structure of the reversible plate receiver.

FIG. 13 is a plan view of an assembled battery according to an embodiment of the present invention.

FIG. 14 is a partial plan view illustrating a coupling process of the assembled battery illustrated in FIG. 13.

FIG. 15 is a schematic cross-sectional view of a conventional secondary battery.

FIG. 16 is an enlarged cross-sectional view of the secondary battery illustrated in FIG. 15.

### DESCRIPTION OF EMBODIMENTS

Embodiments and examples of the present invention will be described on the basis of the drawings. Note that the following embodiments and examples illustrate a secondary battery and an assembled battery including a plurality of secondary batteries for embodying the technical ideas of the present invention, and the present invention does not limit the secondary battery and the assembled battery to those described below. The present specification is by no means intended to limit the components described in the claims to those in the embodiments. Unless otherwise specified, the dimensions, materials, shapes, relative positions, and the like of the components described in the embodiments are merely illustrative examples and are not presented to limit the scope of the present invention thereto. In the following description, the same names and reference numerals represent the same or similar components and detailed description will be omitted as appropriate. A plurality of elements of the present invention may be formed by a single component that serves the functions of the plurality of elements or, conversely, a plurality of components may serve the function of a single element.

### First Embodiment

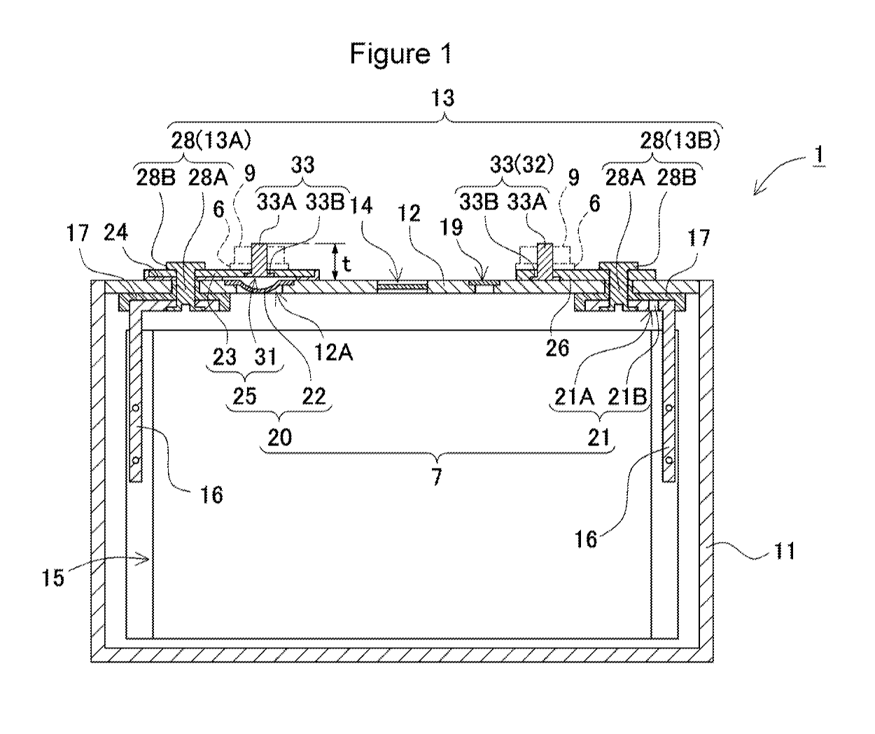

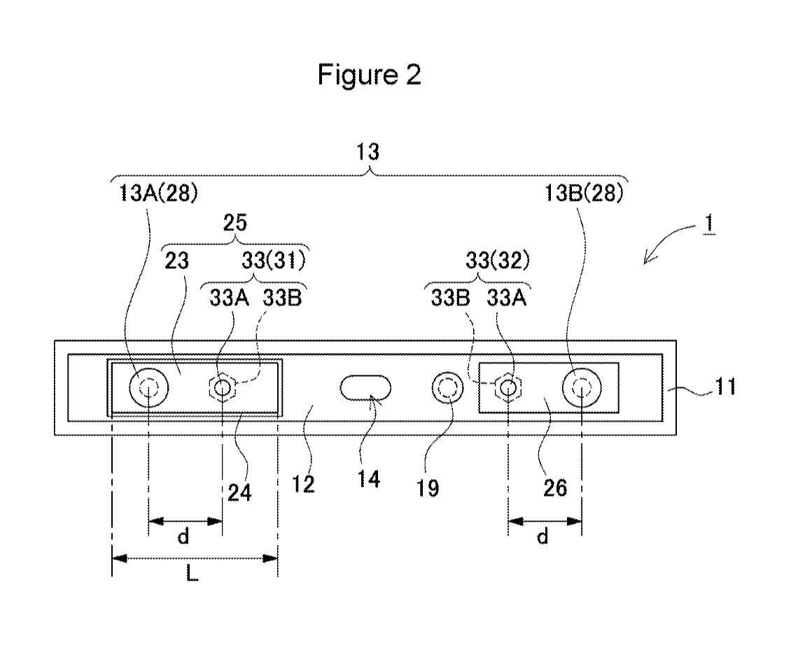

A secondary battery according to a first embodiment of the present invention is illustrated in FIGS. 1 and 2. A secondary battery 1 illustrated in these drawings is a battery prismatic in outer shape and having a thickness smaller than a width thereof. The secondary battery 1 is a battery capable of charging and discharging, such as a lithium-ion secondary battery, a nickel-metal-hydride secondary battery, or a nickel-cadmium secondary battery. In particular, when a lithium-ion secondary battery is used as the secondary battery 1, it is possible to increase charging capacity for the volume or mass of the entire secondary battery.

As illustrated in FIG. 1, the secondary battery 1 includes an electrode body 15 including a positive electrode and a negative electrode, a bottomed tubular outer can 11 having an opening in one surface thereof and holding the electrode body 15, a sealing plate 12 configured to close the opening in the outer can 11, and a pair of electrode terminals disposed at both end portions of the sealing plate 12 and electrically connected through collecting members 16 to the electrode body 15. The electrode body 15 is formed by the positive and negative electrodes wound in a spiral manner with a separator therebetween, pressed to a predetermined thickness, and inserted in the outer can 11. The outer can 11 is a tubular member closed at the bottom, having opposite wide surfaces, and opening upward in the drawing. The outer can 11 of this shape is manufactured by pressing a metal plate, such as an aluminum plate or an aluminum alloy plate. The opening in the outer can 11 is closed, by laser welding, with the sealing plate 12 which is a flat member formed by pressing a metal plate.

The sealing plate 12 has a gas exhaust valve 14 between the electrode terminals 13. The gas exhaust valve 14 is configured to open and release internal gas when the internal pressure of the outer can 11 exceeds a predetermined value. Opening the gas exhaust valve 14 can reduce an increase in the internal pressure of the outer can 11. The gas exhaust valve 14 is preferably disposed in substantially the center of the sealing plate 12 in the longitudinal direction. Thus, even when adjacent secondary batteries 1 are stacked in orientations opposite in the width direction, the gas exhaust valve 14 is always located in the center of the sealing plate 12. The sealing plate 12 has an injection port 19 adjacent to the gas exhaust valve. The injection port 19 is for injecting an electrolytic solution into the outer can 11. The secondary battery 1 is manufactured by inserting the electrode body 15 into the outer can 11, hermetically sealing the opening in the outer can 11 with the sealing plate 12, and injecting the electrolytic solution (not shown) through the injection port 19.

The pair of electrode terminals 13 includes a first electrode terminal 13A insulated from the sealing plate 12, and a second electrode terminal 13B electrically connected to the sealing plate 12. The electrode terminals 13 are each secured in place to the sealing plate 12, with a gasket 17 interposed therebetween. The first electrode terminal 13A is coupled in an insulated state to the sealing plate 12, with the gasket 17 interposed therebetween. The second electrode terminal 13B is coupled to the sealing plate 12 with the gasket 17 interposed therebetween, and is electrically connected to the sealing plate 12 with a conductive plate 26 interposed therebetween. The conductive plate 26 is a metal plate secured, on the upper surface of the sealing plate 12, to the second electrode terminal 13B. The positive and negative electrode terminals 13 secured to the sealing plate 12 are electrically connected through the collecting members 16 to the electrode body 15, in the interior of the secondary battery 1. In the secondary battery 1, the second electrode terminal 13B connected to the sealing plate 12 and the outer can 11 serves as a positive electrode, and the first electrode terminal 13A serves as a negative electrode.

### (Current Interrupt Device 7)

To prevent thermal runaway caused by overcharging or the like, the secondary battery 1 includes a current interrupt device 7 configured to interrupt the electrical connection between the second electrode terminal 13B and the electrode body 15 in response to a rise in the internal pressure of the outer can 11. The current interrupt device 7 illustrated in the drawing includes a short-circuit mechanism 20 configured to short-circuit the first electrode terminal 13A and the sealing plate 12 when the internal pressure of the secondary battery 1 exceeds a set pressure, and a fuse portion 21 in the collecting member 16 connected to the second electrode terminal 13B. In the current interrupt device 7, when the internal pressure of the battery exceeds a set pressure and the short-circuit mechanism 20 makes a short circuit, the fuse portion 21 is blown by overcurrent flowing through the fuse portion 21 and this interrupts the current.

### (Short-Circuit Mechanism 20)

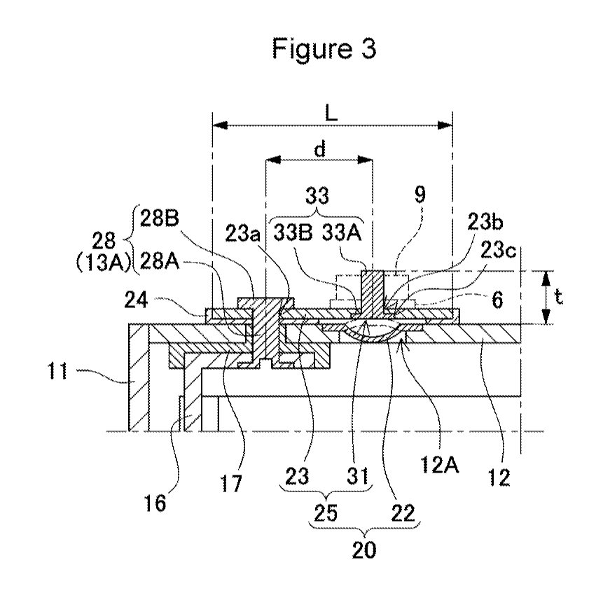

If the internal pressure of the secondary battery 1 exceeds a set pressure as a result of overcharging or the like, the short-circuit mechanism 20 functions to induce a short circuit and allow large current to flow through the fuse portion 21. The short-circuit mechanism 20 illustrated in FIGS. 1 and 3 includes a reversible plate 22 made of a conductive material and secured to the sealing plate 12, and a metal reversible plate receiver 25 disposed on the upper side of the sealing plate 12 to face the reversible plate 22. With the short-circuit mechanism 20, further progress of overcharging can be suppressed even without the fuse portion 21.

### (Reversible Plate 22)

As illustrated in FIGS. 1 and 3, the reversible plate 22 is provided by welding or the like in a short-circuit hole 12A formed in the sealing plate 12. The reversible plate 22 is electrically connected at the outer edge thereof to the sealing plate 12, and is curved at the center thereof to protrude toward the interior of the outer can 11. When overcharging occurs in the secondary battery 1 and the internal pressure of the secondary battery 1 exceeds a set pressure, the reversible plate 22 is reversed to bulge upward. That is, the reversible plate 22 protrudes away from the electrode body 15 and comes into contact with the reversible plate receiver 25 to induce a short circuit.

The working pressure of the reversible plate 22 is preferably set to a value lower than the working pressure of the gas exhaust valve 14. The reversible plate 22 may be formed by pressing the sealing plate 12. Although there is one reversible plate 22 in the short-circuit mechanism 20 of the example described above, there may be a plurality of reversible plates stacked together. In a short-circuit mechanism including a plurality of reversible plates stacked together, the reversible plates have different thicknesses or are configured to reverse at different set pressures, so that the reversible plates smoothly respond to a rise in battery internal pressure. At the same time, even when one reversible plate is melted by heat, another reversible plate maintains a short circuit to allow the fuse portion to continuously perform the fuse function. The reversible plate 22 is preferably made of metal. For example, the reversible plate 22 is preferably an aluminum plate or an aluminum alloy plate.

### (Reversible Plate Receiver 25)

The reversible plate receiver 25 is disposed on the upper surface of the sealing plate 12 with the insulating member 24 interposed therebetween, and is insulated from the sealing plate 12. The reversible plate receiver 25 is electrically connected to the first electrode terminal 13A. The reversible plate receiver 25 illustrated in FIG. 3 includes a connecting plate 23. Specifically, the reversible plate receiver 25 is coupled to the collecting member 16, through the first electrode terminal 13A inserted in a through hole 23a formed in part of the connecting plate 23. The first electrode terminal 13A illustrated in FIG. 3 is a connecting member 28 having a collar portion 28B at one end of a rod portion 28A. The connecting member 28 penetrates the connecting plate 23, the insulating member 24, the sealing plate 12, the gasket 17, and the collecting member 16, with the rod portion 28A passing therethrough. The connecting plate 23 is electrically connected to the collecting member 16 by bringing the collar portion 28B into contact with the upper surface of the connecting plate 23 and swaging an end portion of the rod portion 28A. With this structure where the connecting plate 23, the insulating member 24, the sealing plate 12, the gasket 17, and the collecting member 16 are secured together by swaging the connecting member 28, the height of protrusion from the surface of the sealing plate and the battery height can be reduced. The connecting plate 23 is preferably made of metal. For example, the connecting plate 23 is preferably an aluminum plate, an aluminum alloy plate, a copper plate, or a copper alloy plate. It is particularly preferable that the connecting plate 23 be an aluminum plate or an aluminum alloy plate. When the connecting plate 23 is a copper plate or a copper alloy plate, it is preferable that the connecting plate 23 be surface-plated.

### (Fuse Portion 21)

When the short-circuit mechanism 20 is in a short-circuit state, the fuse portion 21 is melted and cut off by heat from overcurrent flowing in the battery. The fuse portion 21 is located in a conduction path through which current passes when a short circuit occurs. The fuse portion 21 illustrated in FIG. 1 is disposed in the collecting member 16 connected to the second electrode terminal 13B. The fuse portion 21 in the collecting member 16 is configured to be blown by overcurrent flowing through the collecting member 16 when the short-circuit mechanism 20 is in a short-circuit state. The fuse portion 21 illustrated in FIG. 1 is formed by a fuse hole 21A in the collecting member 16. Specifically, the fuse portion 21 is formed by a connecting portion 21B on both sides of the fuse hole 21A. The cross-sectional area of the connecting portion 21B is reduced by the opening of the fuse hole 21A. When electrical resistance is locally increased, the connecting portion 21B functions as a fuse that interrupts current by being melted by heat from large current that flows when the secondary battery 1 is short-circuited. When the connecting portion 21B is melted and cut off in the region where the fuse hole 21A is formed, the fuse portion 21 is electrically separated and interrupts the current. As illustrated in FIG. 1, the fuse portion 21 is disposed above the electrode body 15 contained in the outer can 11, and outside the electrode terminal 13.

The current interrupt device 7 illustrated in FIG. 1 has the fuse portion 21 in the collecting member 16 connected to the second electrode terminal 13B. With this structure, where the short-circuit mechanism 20 and the fuse portion 21 are spaced apart, the adverse effect of sparks, which are produced when the fuse portion 21 is blown or conducts current again, on the short-circuit mechanism 20 can be reduced. Alternatively, the fuse portion may be disposed in the collecting member connected to the first electrode terminal.

When the internal pressure of the secondary battery 1 exceeds a set pressure, the reversible plate 22 in the current interrupt device 7 is deformed and reversed by being pushed upward by the internal pressure. When the reversible plate 22 is reversed and brought into contact with the reversible plate receiver 25, the reversible plate 22 and the reversible plate receiver 25 are electrically connected and the short-circuit mechanism 20 is short-circuited. When the short-circuit mechanism 20 is short-circuited, large current flows in the secondary battery 1. Then the fuse portion 21 in the conduction path is heated, melted, and cut off by Joule heat from the large current, and interrupts the current. Thus, when the internal pressure of the secondary battery 1 is abnormally increased, the current flowing in the secondary battery 1 is interrupted to ensure safety of the secondary battery 1.

### (First Output Terminal 31)

In the secondary battery 1 illustrated in the drawings, the reversible plate receiver 25 further includes a first output terminal 31. The first output terminal 31 is electrically connected through the connecting plate 23 to the first electrode terminal 13A. The first output terminal 31 illustrated in FIGS. 1 and 3 is a bolt 33 having a head portion 33B at the rear end of a bolt portion 33A. The bolt 33 penetrates the connecting plate 23 with the bolt portion 33A facing upward. The connecting plate 23 has an insertion hole 23b into which the bolt portion 33A is inserted, and also has, at the lower opening of the insertion hole 23b, a fitting recess 23c into which the head portion 33B of the bolt 33 is fitted. As illustrated in FIG. 2, the head portion 33B of the bolt 33 is polygonal (hexagonal in the drawing) in outer shape. The fitting recess 23c is internally shaped to fit the contour of the head portion 33B, which is thus secured by the fitting structure. Since the head portion 33B is polygonal in plan view, a nut 9 can be tightened without allowing the bolt 33 to turn freely. The head portion 33B may be circular in plan view. When the head portion 33B is circular in plan view, the bolt 33 is preferably secured to the connecting plate 23 by being press-fitted into the insertion hole 23b in the connecting plate 23. The bolt 33 can be firmly secured by press-fitting the bolt portion 33A into the insertion hole 23b, by press-fitting the head portion 33B into the fitting recess 23c, by swaging the head portion 33B, or by bonding or welding. The first output terminal 31 is preferably made of metal. The material of the first output terminal 31 is not particularly limited. A material with lower conductivity than that of the connecting plate 23 may be used to form the first output terminal 31.

The first output terminal 31 is spaced from the first electrode terminal 13A. In the secondary battery 1 illustrated in FIGS. 1 and 2, the first electrode terminal 13A is disposed at an end portion of the sealing plate 12, and the first output terminal 31 is spaced from the first electrode terminal 13A toward the center of the sealing plate 12. That is, in the longitudinal direction of the sealing plate 12, the first output terminal 31 is disposed closer to the center (i.e., gas exhaust valve 14) than the first electrode terminal 13A is. The first output terminal 31 is thus disposed at a distance from the first electrode terminal 13A. Therefore, when the first output terminal 31 is secured, with the bus bar 6 thereon, by tightening it with the nut 9, the tightening torque exerted on the first output terminal 31 can be prevented from applying excessive stress to the first electrode terminal 13A. By increasing a distance (d) between the first output terminal 31 and the first electrode terminal 13A, the adverse effect of the tightening torque for tightening the nut 9 on the first electrode terminal 13A can be reduced. To increase the distance (d) between the first output terminal 31 and the first electrode terminal 13A, however, it is necessary to increase the length of the connecting plate 23 and this restricts placement on the sealing plate 12. By taking this into account, the distance (d) between the first output terminal 31 and the first electrode terminal 13A is determined to be within an optimum range. The distance (d) between the first output terminal 31 and the first electrode terminal 13A is, for example, 15% to 80% of an overall length (L) of the connecting plate 23 and preferably 25% to 70% of the overall length (L).

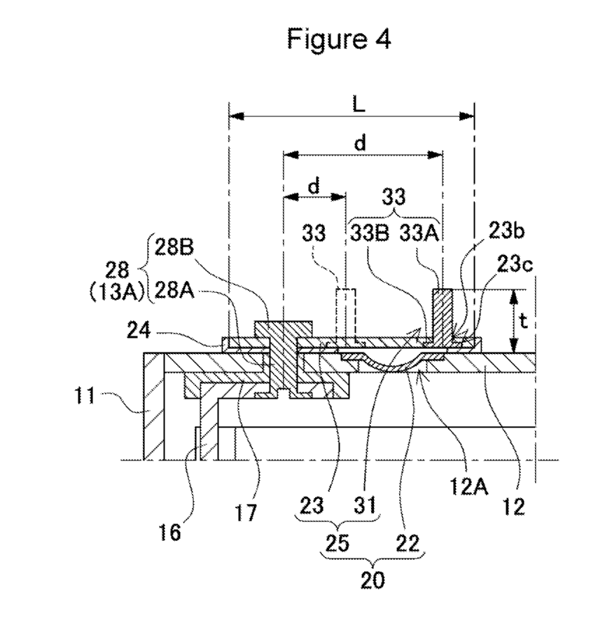

In the secondary battery illustrated in FIGS. 1 and 3, the head portion 33B of the bolt 33, which is the first output terminal 31, is disposed opposite the reversible plate 22. The reversible plate receiver 25 is configured such that when the reversible plate 22 is reversed as indicated by a chain line in FIG. 3, the reversible plate 22 comes into contact with the head portion 33B of the bolt 33 to induce a short circuit. With this structure, the contact resistance and conduction resistance can be reduced by selecting materials most suitable for the reversible plate 22 and the bolt 33. As illustrated in FIG. 4, the bolt 33, which is the first output terminal 31, may be moved away from the position opposite the reversible plate 22. That is, the bolt 33 may be displaced in a direction away from the first electrode terminal 13A. In this structure, the reversible plate 22 in a reversed state comes into contact with the lower surface of the connecting plate 23. Thus, by increasing the distance (d) between the first output terminal 31 and the first electrode terminal 13A, the effect of the tightening torque for tightening the nut 9 on the first electrode terminal 13A can be further reduced. As indicated by a chain line in FIG. 4, the bolt 33, which is the first output terminal 31, may be moved from the position opposite the reversible plate 22 toward the first electrode terminal 13A. By reducing the distance (d) between the first output terminal 31 and the first electrode terminal 13A, the conduction distance from the electrode body 15 to the first output terminal 31 is reduced and this reduces resistance. With either of the configurations illustrated in FIG. 4, even if the first output terminal 31 moves downward from the connecting plate 23, it is possible to reliably prevent the reversible plate 22 from being damaged by contact with the first output terminal 31 and prevent the short-circuit mechanism 20 from malfunctioning. To achieve this, it is preferable that the central axis of the first output terminal 31 be off the center of the reversible plate 22, and that at least part of the first output terminal 31 (e.g., part of the head portion 33B) be positioned outside the short-circuit hole 12A. Additionally, it is preferable that the central axis of the first output terminal 31 be located outside the short-circuit hole 12A. Also, as illustrated in FIG. 4, it is preferable that an insulating member, such as the insulating member 24, be partly disposed between the head portion 33B and the sealing plate 12. Also, when the first output terminal 31 is displaced from the position opposite the reversible plate 22, as illustrated in FIG. 4, to allow the reversible plate 22 in a reversed state to come into contact with the connecting plate 23, it is preferable that the lower surface of the connecting plate 23 be provided with a protrusion, which is brought into contact with the reversible plate 22.

### (Other Examples of Connecting Member 28)

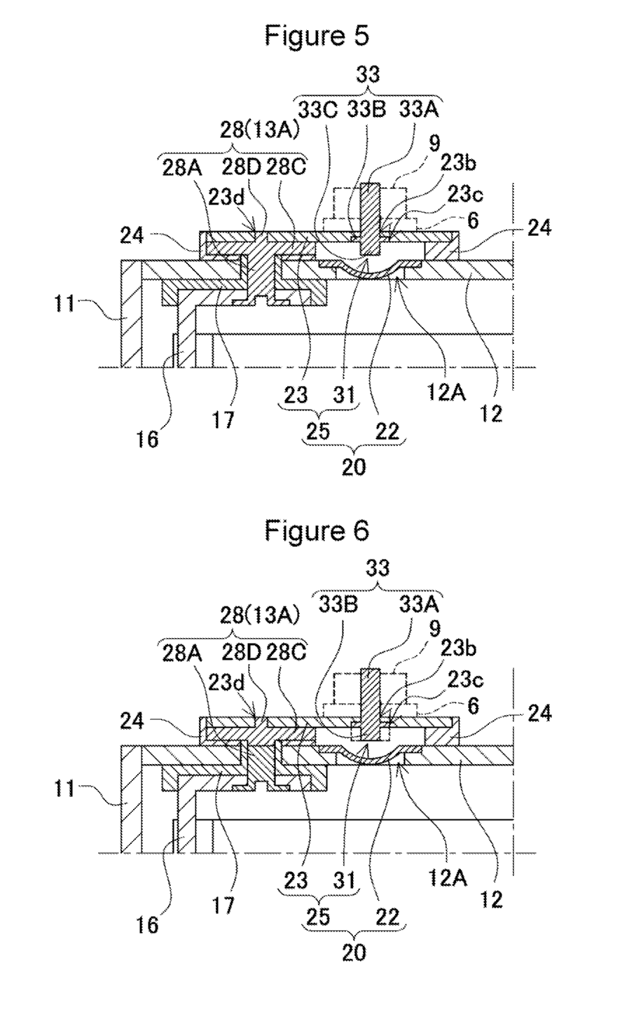

The connection between the reversible plate receiver 25 and the collecting member 16 may be made by the structure illustrated in FIG. 5 or 6. In the first electrode terminal 13A illustrated in FIG. 5, the collar portion at one end of the rod portion 28A is a rectangular terminal plate 28C shaped to fit the inner contour of the insulating member 24. The connecting plate 23 forming the reversible plate receiver 25 is coupled in surface contact with the outer side of the terminal plate 28C. The connecting member 28 penetrates the insulating member 24, the sealing plate 12, the gasket 17, and the collecting member 16, with the rod portion 28A passing therethrough. In the connecting member 28, with the terminal plate 28C being in contact with the upper surface of the insulating member 24, the rod portion 28A is swaged at an end portion thereof to electrically connect the terminal plate 28C to the collecting member 16 and secure the terminal plate 28C to the surface of the insulating member 24. The connecting member 28 has a coupling protrusion 28D protruding from the outer side thereof for coupling to the connecting plate 23. The connecting plate 23 has a coupling hole 23d at a position corresponding to the coupling protrusion 28D. By inserting the coupling protrusion 28D into the coupling hole 23d, the connecting plate 23 is coupled in place to the terminal plate 28C. In the process of manufacturing the secondary battery 1, after the collecting member 16 is secured to the sealing plate 12 through the connecting member 28 including the terminal plate 28C, the collecting member 16 is placed in the outer can 11 and the outer can 11 is closed with the sealing plate 12. This is followed by connecting the connecting plate 23 to the terminal plate 28C. This means that the shape of the bolt 33 can be easily changed in accordance with the intended use. In this example, a good connection can be achieved when the connecting member 28 and the connecting plate 23 are copper members and the bolt 33 is a plated iron bolt.

In the connecting member 28 illustrated in FIG. 6, the rod portion 28A and the terminal plate 28C are of different metals. In the connecting member 28 illustrated in the drawing, the rod portion 28A is a copper member, and the terminal plate 28C is an aluminum member. When the connecting plate 23 is an aluminum member, this structure facilitates laser welding between the terminal plate 28C and the connecting plate 23 which are of the same metal. Weight reduction can thus be achieved.

In the secondary battery 1 illustrated in FIGS. 5 and 6, the terminal plate 28C of the connecting member 28 is interposed between the connecting plate 23 and the insulating member 24. Although this increases the distance between the reversible plate 22 and the connecting plate 23, the head portion 33B has a protrusion 33c (see FIG. 5) in the center thereof to secure a distance to the reversible plate 22, or the bolt 33 has the head portion 33B formed with an increased thickness (as indicated by a chain line in FIG. 6) to secure a distance to the reversible plate 22. This maintains a connection between the reversible plate 22 and the bolt 33 when the reversible plate 22 is activated and reversed.

### (Other Examples of Bolt 33)

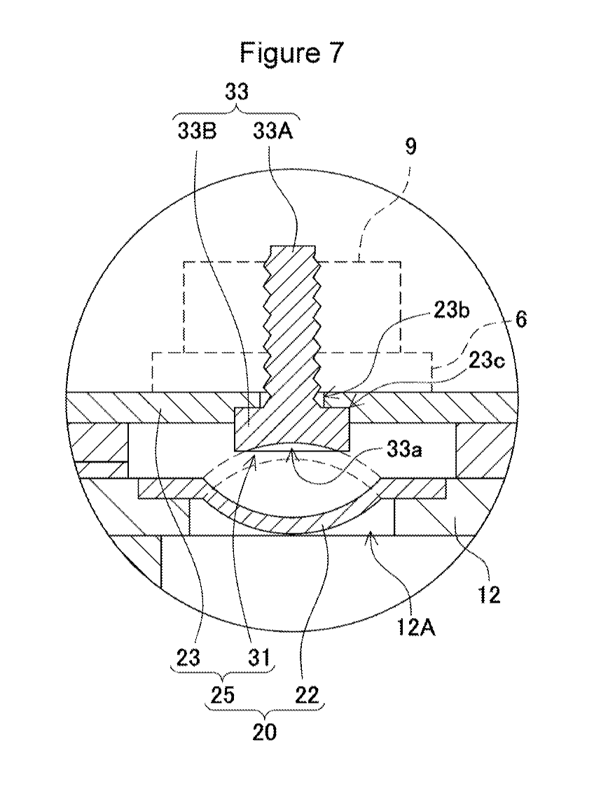

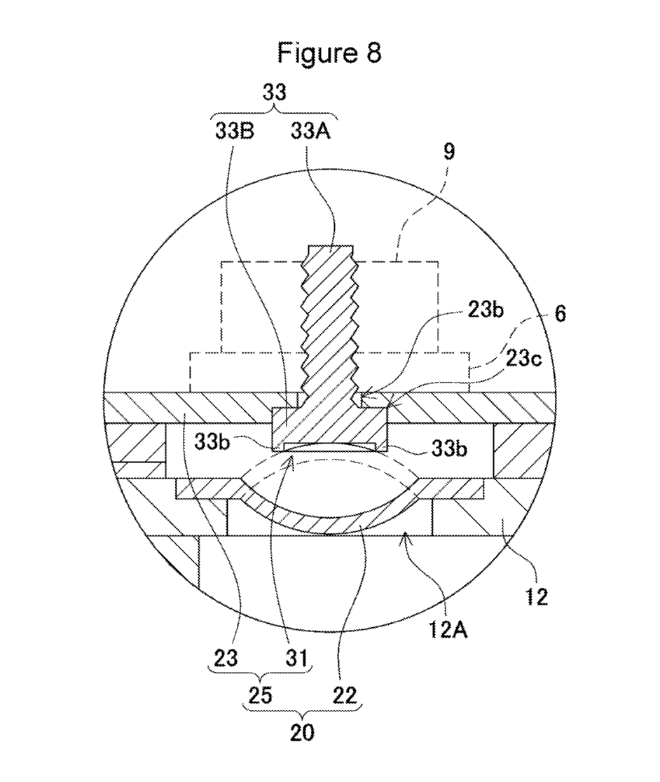

In the structure where the head portion 33B of the bolt 33 is formed with an increased thickness at the position opposite the reversible plate 22, the shape of the head portion 33B can be variously changed, as illustrated in FIGS. 7 and 8, to reduce contact resistance and conduction resistance with the reversible plate 22.

The bolt 33 illustrated in FIG. 7 has a recess 33a in the surface of the head portion 33B, or in the lower surface of the bolt 33 opposite the reversible plate 22 in the drawing. The recess 33a of the head portion 33B preferably has a cross-sectional shape that follows, as indicated by a chain line in the drawing, the surface of the reversible plate 22 in a reversed state. This configuration facilitates contact between the reversible plate 22 and the head portion 33B in a larger area when the reversible plate 22 is reversed, and can reduce contact resistance and conduction resistance between the head portion 33B and the reversible plate 22.

The bolt 33 illustrated in FIG. 8 has an annular raised portion 33b on the surface of the head portion 33B or the lower surface of the bolt 33 opposite the reversible plate 22 in the drawing. The annular raised portion 33b of the bolt 33 illustrated in FIG. 8 is along the outer circumference of the head portion 33B. The raised portion 33b is formed such that the bolt 33 has a shape that follows, as indicated by a chain line in the drawing, the surface of the reversible plate 22 in a reversed state. This can also reduce contact resistance and conduction resistance with the reversible plate 22. A certain effect can be achieved even when the annular raised portion 33b is a substantially annular raised portion which is partly notched or interrupted. For example, when the length of an actual raised portion is at least 70% of the entire circumference of a perfect annular raised portion, the actual raised portion can be defined as a substantially annular raised portion.

### (Other Examples of Reversible Plate Receiver 25)

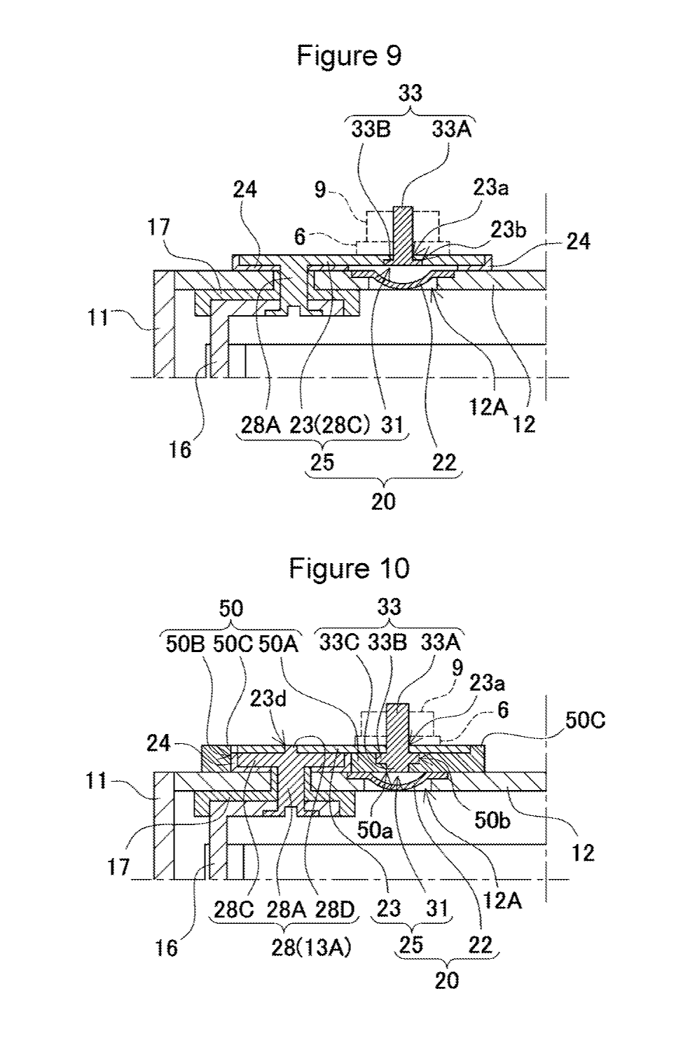

As illustrated in FIG. 9, the connecting member 28, which is the first electrode terminal 13A, and the connecting plate 23 may be integrally formed to provide the reversible plate receiver 25. In the reversible plate receiver 25, the connecting plate 23 disposed on the upper surface of the sealing plate 12, with the insulating member 24 interposed therebetween, serves as the terminal plate 28C of the connecting member 28 and is integrally formed with the rod portion 28A protruding downward from the connecting plate 23. This structure, where the connecting plate and the connecting member are integrally formed, can not only achieve lower resistance because there is no contact resistance attributed to joining of different metals, but can also reduce the number of components.

As described above, in the secondary battery of the present invention, the reversible plate receiver 25 includes the first output terminal 31, which is spaced from the first electrode terminal 13A. This can reduce the amount of protrusion (t) of the first output terminal 31 to which the bus bar 6 and the nut 9 are coupled, and thus can reduce the overall height of the secondary battery 1. When the nut 9 is tightened onto the first output terminal 31, the tightening torque exerted on the first output terminal 31 can be prevented from applying excessive stress to the first electrode terminal 13A.

### (Insulating Holder 50)

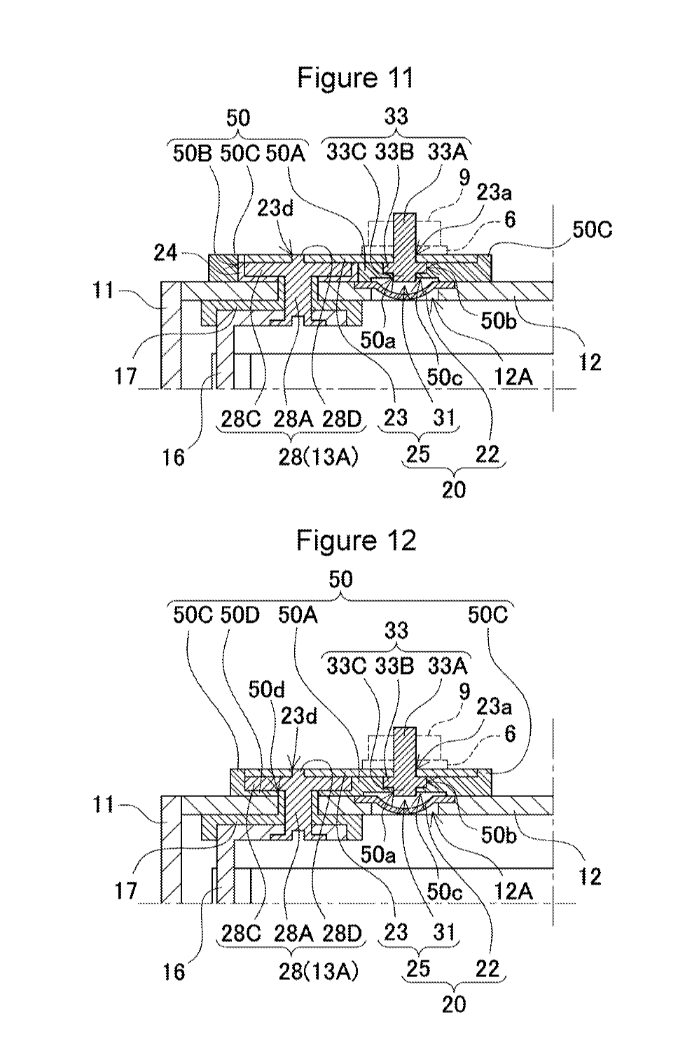

In the structures illustrated in FIGS. 10 to 12, the reversible plate receiver 25 may be positioned in place in the sealing plate 12. In the examples illustrated in FIGS. 10 to 12, an insulating holder 50 formed of an insulating material, such as resin, is disposed on the upper surface of the reversible plate 22. The insulating holder 50 illustrated in FIGS. 10 and 11 has a plate portion 50A opposite the reversible plate 22, and the plate portion 50A has a through hole 50a for insertion of part of the bolt 33. The insulating holder 50 has a cavity 50B opposite the connecting member 28. The connecting member 28 and the insulating member 24 are disposed in the cavity 50B. The insulating holder 50 with this structure is disposed in place on the upper surface of the sealing plate 12, with the connecting member 28 and the insulating member 24 disposed in the cavity 50B. Additionally, the insulating holder 50 illustrated in the drawings has a peripheral wall 50C along the circumference of the upper surface thereof. The connecting plate 23 is fitted inside the peripheral wall 50C and positioned in place.

Part of the bolt 33 is inserted into the through hole 50a formed in the plate portion 50A of the insulating holder 50, and the part of the bolt 33 in the through hole 50a is exposed from the plate portion 50A on the lower side of the through hole 50a. The bolt 33 illustrated in FIGS. 10 to 12 has, at the center of the head portion 33B, the columnar protrusion 33C protruding downward. The protrusion 33C passes through the through hole 50a. The protrusion 33C on the head portion 33B of the bolt 33 penetrates the insulating holder 50 and is exposed on the lower side, so that the protrusion 33C is brought into contact with and electrically connected to the reversible plate 22 in a reversed state. The through hole 50a has an inside diameter which allows insertion of the protrusion 33C, but does not allow insertion of the head portion 33B. That is, the inside diameter of the narrowest part of the through hole 50a is smaller than the outside diameter of the widest part of the head portion 33B of the bolt 33. This prevents the bolt 33 disposed above the reversible plate 22 from moving toward the reversible plate 22. Therefore, in a normal state, the bolt 33 can be reliably prevented from moving downward and coming into contact with the reversible plate 22. When the reversible plate 22 is in a reversed state, the reversible plate 22 can come into contact with the protrusion 33C exposed from the through hole 50a.

The through hole 50a in the insulating holder 50 preferably has a stepped portion with which the head portion 33B and the protrusion 33C are fitted. The insulating holder 50 illustrated in FIGS. 10 to 12 has, at the upper opening of the through hole 50a, a stepped recess 50b into which the head portion 33B of the bolt 33 is inserted. To accommodate the head portion 33B, the stepped recess 50b is internally shaped to fit the contour of the head portion 33B, or is shaped slightly larger than the contour of the head portion 33B and deep enough to accommodate the head portion 33B.

The insulating holder 50 can reliably prevent the bolt 33 secured to the connecting plate 23 from moving toward the reversible plate 22 while allowing the reversible plate receiver 25 to be positioned in place on the sealing plate 12. With the insulating holder 50 in which the bolt 33 is positioned in place, the bolt 33 does not necessarily need to be secured to the connecting plate 23 by press-fitting, welding, or the like. This is because the connecting plate 23 can be electrically connected to the bus bar 9 by positioning the bolt 33 in place in the insulating holder 50, positioning the connecting plate 23 with the bolt portion 33A of the bolt 33 penetrating the connecting plate 23, allowing the bolt portion 33A protruding from the connecting plate 23 to pass through the bus bar 6, and tightening the nut 9. To tighten the nut 9 without allowing the bolt 33 to turn freely, it is preferable that the head portion 33B of the bolt 33 be polygonal in plan view and that the stepped recess 50b be internally shaped to fit the contour of the head portion 33B.

The protrusion 33C of the bolt 33 protrudes such that, with the head portion 33B being guided into the stepped recess 50b, the lower end face of the protrusion 33C inserted in the through hole 50a is exposed at the lower surface of the plate portion 50A. The lower surface of the plate portion 50A of the insulating holder 50 illustrated in FIG. 10 is flush with the upper surface of the sealing plate 12. The lower face of the protrusion 33C exposed from the through hole 50a in the insulating holder 50 is flush with the lower surface of the plate portion 50A of the insulating holder 50. The lower end of the protrusion 33C of the bolt 33 may protrude from the lower surface of the plate portion 50A.

The insulating holder 50 illustrated in FIG. 11 has a recess 50c in the lower surface of the plate portion 50A around the opening edge of the through hole 50a. The recess 50c is formed in a region opposite the reversible plate 22. With the recess 50c around the through hole 50a, the insulating holder 50 allows the lower end of the protrusion 33C to protrude from the bottom surface of the recess 50c, and exposes the lower face of the bolt 33 toward the reversible plate 22. When the reversible plate 22 is reversed, this structure ensures a good contact between the reversible plate 22 and the lower face of the bolt 33.

As illustrated in FIGS. 10 and 11, the insulating holder 50 can be provided as a component separate from the insulating member 24. This allows the insulating holder 50 to be separately connected after the connecting member 28, which is the first electrode terminal 13A, is secured to the sealing plate 12, and improves the degree of freedom in the manufacturing process. The insulating holder may be provided as part of the insulating member.

The insulating holder 50 illustrated in FIG. 12 forms an integral structure with the insulating member 24. The insulating holder 50 does not have a cavity at the position opposite the connecting member 28, which is the first electrode terminal 13A. The lower surface of the insulating holder 50 is closed with a plate portion 50D, which is provided with a through hole 50d that allows the rod portion 28A of the connecting member 28 to pass therethrough. This structure, where the insulating member 24 is integral with the insulating holder 50, can reduce the number of components.

The insulating holder 50, which is coupled at one end portion thereof to the connecting member 28 or the insulating member 24, can be placed while being positioned in place on the upper surface of the sealing plate 12. However, the insulating holder 50 does not necessarily need to be coupled at one end portion thereof to the connecting member 28 or the insulating member 24, and may be formed only by the plate portion 50A opposite the reversible plate 22. This insulating holder (not shown) is disposed between the connecting plate and the reversible plate, and functions as a stopper member that blocks the bolt disposed above the reversible plate from moving toward the reversible plate. This insulating holder can be disposed, for example, inside the insulating member 24 of the structure illustrated in FIG. 5 or 6, and between the connecting plate 23 and the reversible plate 2.

### (Second Output Terminal)

The secondary battery 1 illustrated in FIGS. 1 and 2 also includes a second output terminal 32 for outputting externally an output from the electrode body 15 connected to the second electrode terminal 13B. The second output terminal 32 is secured to the conductive plate 26, through which it is electrically connected to the second electrode terminal 13B. The second output terminal 32 illustrated in FIGS. 1 and 2 has the same structure as the first output terminal 31. That is, the second output terminal 32 is a bolt 33 having a head portion 33B at the rear end of a bolt portion 33A. The bolt 33 penetrates the conductive plate 26 with the bolt portion 33A facing upward. The conductive plate 26 has an insertion hole into which the bolt portion 33A is inserted, and also has, at the lower opening of the insertion hole, a fitting recess into which the head portion 33B of the bolt 33 is fitted. This bolt 33 can also be firmly secured by press-fitting the head portion 33B into the fitting recess, or can be secured by bonding or welding. The head portion 33B of the bolt 33 is also polygonal in outer shape, and the fitting recess is internally shaped to fit the contour of the head portion 33B, which is thus secured by the fitting structure.

The conductive plate 26 allows the second output terminal 32 to be spaced from the second electrode terminal 13B. In the secondary battery 1 illustrated in FIGS. 1 and 2, the second electrode terminal 13B is disposed at an end portion of the sealing plate 12. The second output terminal 32 is spaced from the second electrode terminal 13B toward the center of the sealing plate 12.

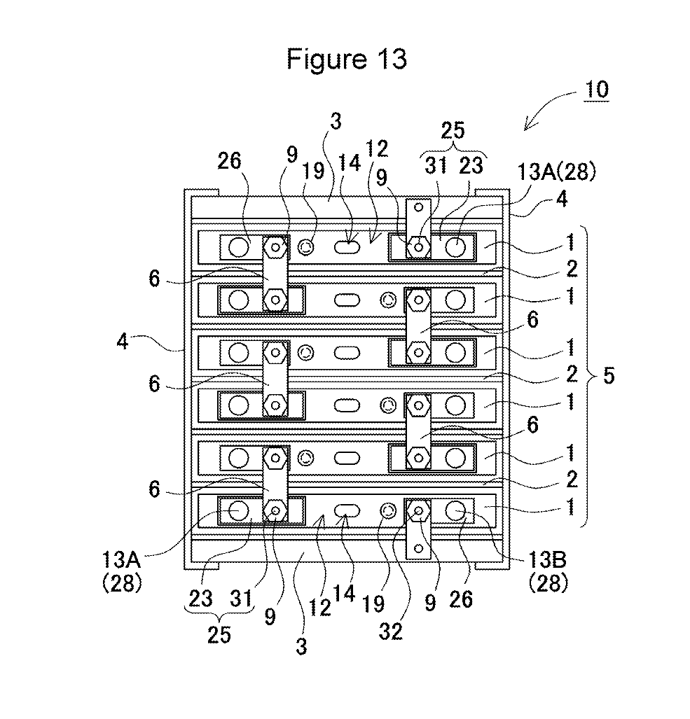

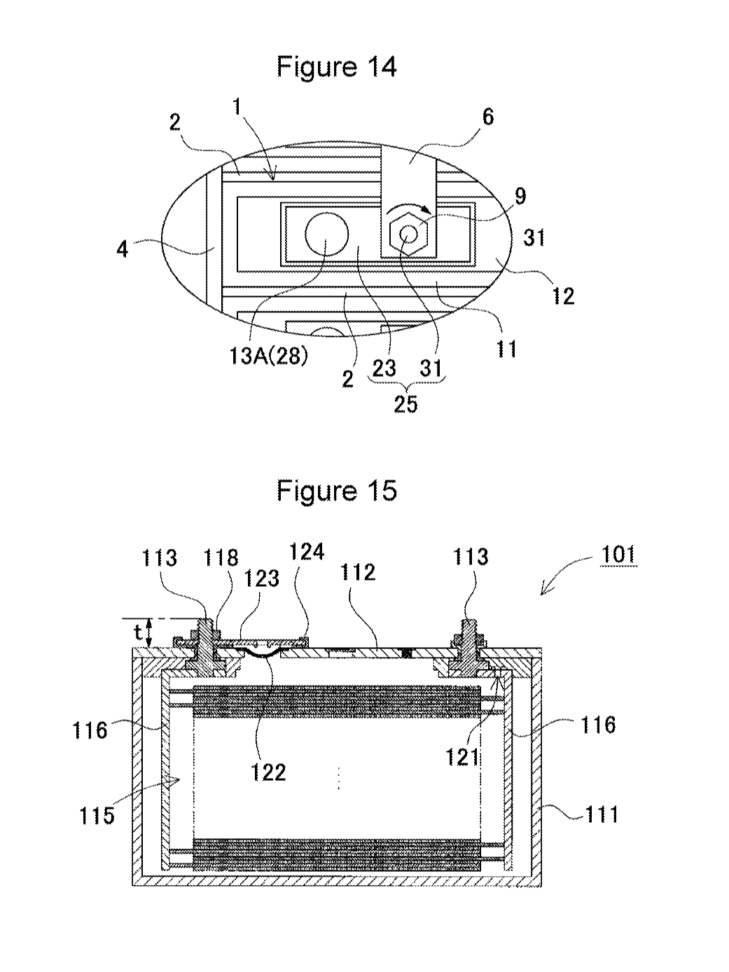

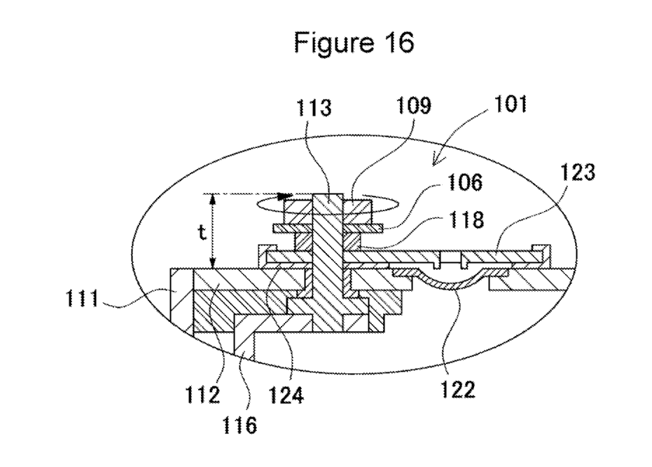

The first output terminal 31 and the second output terminal 32 are preferably arranged such that when a plurality of secondary batteries 1 are stacked while being alternately reversed as illustrated in FIG. 13, the output terminals of adjacent secondary batteries 1 are located opposite each other. Therefore, the distance (d) between the second output terminal 32 and the second electrode terminal 13B is preferably equal to the distance (d) between the first output terminal 31 and the first electrode terminal 13A. That is, the first output terminal 31 and the second output terminal 32 are symmetrically arranged right and left.

As illustrated in FIG. 13, the secondary batteries 1 are stacked, with wide surfaces (principal surfaces) thereof facing each other, to form an assembled battery such that the upper surfaces of the secondary batteries 1 are flush with each other and the side faces of the secondary batteries 1 are also flush with each other. In the secondary batteries 1 stacked together, the opposite first and second output terminals 31 and 32 of each pair of adjacent secondary batteries 1 are coupled together and connected in series by the bus bar 6. An assembled battery 10 in which adjacent secondary batteries 1 are connected in series has a high output voltage and produces a large output. The assembled battery may have a configuration where adjacent secondary batteries are connected in parallel, or may have a configuration where adjacent secondary batteries are in multiple series-parallel connection which combines series and parallel connections.

As illustrated in the plan view of FIG. 13, in the assembled battery 10 composed of the secondary batteries 1 connected in series, the secondary batteries 1 are stacked in such a manner that the first output terminal 31 and the second output terminal 32 of each pair of adjacent secondary batteries 1 are opposite and close. In other words, the secondary batteries 1 are stacked while being alternately reversed right and left. This can reduce the size of the bus bars 6 each connecting the first output terminal 31 and the second output terminal 32.

### (Assembled Battery 10)

As illustrated in FIG. 13, the assembled battery 10 includes a plurality of secondary batteries 1, a plurality of separators 2 each interposed between surfaces of adjacent ones of the stacked secondary batteries 1 for insulation between the secondary batteries 1, a pair of end plates 3 disposed on respective end faces in the stacking direction of a battery stack 5 formed by alternately stacking the secondary batteries 1 and the separators 2, and a plurality of metal fastening members 4 disposed on respective side faces of the battery stack 5 to fasten together the end plates 3.

### (Separator 2)

The separators 2 are each formed by an insulating member, such as a resin member, and configured to electrically insulate adjacent ones of the secondary batteries 1. The assembled battery does not necessarily need to include the separators each interposed between adjacent ones of the secondary batteries. For example, the outer can of each secondary battery may be formed of an insulating material, such as resin, or the periphery of the outer can of each secondary battery may be covered with heat-shrinkable tubing, insulating sheet, insulating coating, or the like. This insulates adjacent ones of the secondary batteries and eliminates the need for the separators.

### (End Plate 3)

The end plates 3 are made of a material that exhibits sufficient strength, such as metal. The end plates may be made of resin, or the end plates made of resin may be reinforced by a metal member.

### (Fastening Member 4)

The fastening members 4 are binding bars each formed by bending a metal plate having a predetermined thickness into a predetermined shape. Metal plates made of a material having sufficient strength, such as aluminum or iron plates (preferably steel plates), may be used to form such binding bars. Using binding bars formed by bending metal plates as the fastening members 4 can reduce the cost of manufacture.

### INDUSTRIAL APPLICABILITY

A secondary battery and an assembled battery including a plurality of secondary batteries, according to the present invention, are most suitably used in power supply devices that supply power to motors of vehicles which require a large amount of power, and in electrical storage devices that store natural energy or midnight power.

### REFERENCE SIGNS LIST

1: secondary battery

2: separator

3: end plate

4: fastening member

5: battery stack

6: bus bar

7: current interrupt device

9: nut

10: assembled battery

11: outer can

12: sealing plate

12A: short-circuit hole

13: electrode terminal

13A: first electrode terminal

13B: second electrode terminal

14: gas exhaust valve

15: electrode body

16: collecting member

17: gasket

19: injection port

20: short-circuit mechanism

21: fuse portion

22: reversible plate

23: connecting plate

23a: through hole

23b: insertion hole

23c: fitting recess

23d: coupling hole

24: insulating member

25: reversible plate receiver

26: conductive plate

28: connecting member

28A: rod portion

28B: collar portion

28C: terminal plate

28D: coupling protrusion

31: first output terminal

32: second output terminal

33: bolt

33A: bolt portion

33B: head portion

33C: protrusion

33a: recess

33b: raised portion

50: insulating holder

50A: plate portion

50B: cavity

50C: peripheral wall

50D: plate portion

50a: through hole

50b: stepped recess

50c: recess

50d: through hole

106: bus bar

109: nut

101: secondary battery

111: outer can

112: sealing plate

113: electrode terminal

115: electrode body

116: collecting plate

118: securing member

121: fuse portion

122: reversible plate

123: connecting plate

124: insulating member

1. A secondary battery comprising:
an electrode body including a positive electrode and a negative electrode;
an outer can having an opening and holding the electrode body;
a sealing plate configured to close the opening of the outer can; and
a pair of electrode terminals electrically connected to the electrode body and attached to the sealing plate,
wherein the pair of electrode terminals includes a first electrode terminal insulated from the sealing plate and a second electrode terminal electrically connected to the sealing plate,
the secondary battery further comprising a short-circuit mechanism configured to short-circuit the first electrode terminal and the sealing plate when internal pressure of the secondary battery exceeds a set pressure,
wherein the short-circuit mechanism includes a conductive reversible plate secured to the sealing plate and configured to be activated when pressure in the outer can exceeds a set pressure, and a reversible plate receiver disposed on an upper side of the sealing plate to face the reversible plate;
the reversible plate receiver includes a first output terminal;
the first output terminal is electrically insulated from the sealing plate; and
the first output terminal is electrically connected to the first electrode terminal and spaced from the first electrode terminal.

2. The secondary battery according to claim 1, wherein the reversible plate receiver includes a connecting plate configured to connect the first electrode terminal to the first output terminal;
the first output terminal is a bolt having a bolt portion and a head portion adjacent to one end of the bolt portion; and
the bolt is inserted in an insertion hole in the connecting plate.

3. The secondary battery according to claim 2, wherein the connecting plate has a fitting recess adjacent to a lower end of the insertion hole to allow the head portion to be fitted therein.

4. The secondary battery according to claim 3, wherein the bolt is secured to the connecting plate by being press-fitted into the insertion hole or the fitting recess.

5. The secondary battery according to claim 2, wherein the bolt is disposed opposite the reversible plate, and when the reversible plate is activated, the reversible plate is brought into contact with the head portion.

6. The secondary battery according to claim 5, wherein the head portion has a recess in a surface thereof opposite the reversible plate.

7. The secondary battery according to claim 5, wherein the head portion has an annular raised portion on a surface thereof opposite the reversible plate.

8. The secondary battery according to claim 1, wherein the first output terminal is a bolt having a bolt portion and a head portion adjacent to one end of the bolt portion;
an insulating holder is disposed above the reversible plate; and
the insulating holder has a through hole at a position opposite the reversible plate, and the bolt is partly inserted into the through hole and exposed at a lower surface of the insulating holder.

9. The secondary battery according to claim 8, wherein the insulating holder has a stepped recess adjacent to an upper end of the through hole to accommodate the head portion.

10. The secondary battery according to claim 1, further comprising a second output terminal electrically connected to the second electrode terminal,
wherein the second output terminal is connected to the second electrode terminal through a conductive plate disposed on an upper surface of the sealing plate, and is spaced from the second electrode terminal.

11. The secondary battery according to claim 10, wherein the first output terminal and the second output terminal are symmetrically arranged.

12. The secondary battery according to claim 10, wherein the second output terminal is a bolt having a bolt portion and a head portion adjacent to one end of the bolt portion, and the bolt is inserted in an insertion hole in the conductive plate.

13. An assembled battery comprising a plurality of secondary batteries according to claim 1,
wherein the plurality of secondary batteries are connected using bus bars and nuts coupled to the first output terminals.
